(19) United States
(12) Patent Application Publication
(10) Pub. No.: US 2013/0223472 A1
(43) Pub. Date: Aug. 29, 2013

(54) INFRARED TEMPERATURE SENSOR CALIBRATION SYSTEM AND METHOD

(71) Applicant: Robert A. Maston, Columbus, OH (US)

(72) Inventor: Robert A. Maston, Columbus, OH (US)

(73) Assignee: CVG MANAGEMENT CORPORATION, New Albany, OH (US)

(21) Appl. No.: 13/555,715

(22) Filed: Jul. 23, 2012

Related U.S. Application Data
(60) Provisional application No. 61/603,695, filed on Feb. 27, 2012.

(51) Int. Cl. G01K 15/00

(52) U.S. Cl. 374/2; 374/E15.001

(57) ABSTRACT

Systems and methods that facilitate calibrated temperature measurements are discussed. Such a system can include a target object that changes temperature, a test infrared (IR) temperature sensor that can make a first set of measurements of the temperature of the target object over a period of time, and a standard IR temperature sensor that can make a second set of measurements of the temperature of the target object over the period of time. Additionally, the system can include a calibration unit that compares the first set of measurements with the second set of measurements and determines an accuracy of the test IR temperature sensor based on the comparison.

### CROSS-REFERENCE TO RELATED APPLICATIONS

This application claims the benefit of U.S. Provisional Patent application Ser. No. 61/603,695 (Atty. Dkt. No.104308.202PRO) entitled “INFRARED TEMPERATURE SENSOR CALIBRATION SYSTEM AND METHOD” and filed Feb. 27, 2012. The entirety of the above-noted application is incorporated by reference herein.

### BACKGROUND

Infrared (IR) temperature sensors can be used in a variety of applications, such as in connection with vehicles for detection of roadway conditions (e.g., icing and ice-forming conditions, etc.). Field measurements generally use sensors and provide measurements that are less precise and less accurate than those available in controlled conditions, laboratories, factories, etc.

IR temperature sensors work by detecting the about of thermal energy given off by an object in its field of view. As a camera picks up the intensity and color of light to recreate an image, an IR detector must ‘see’ its target. The IR intensity is related to the temperature as well as the emissivity, which can be thought of as the surface type or ‘color’ of the object(s) viewed by the sensor. The emissivity of a perfect ‘black body’ is defined to be 1.0. As examples related to roadway temperature sensing, concrete and asphalt have an emissivity around 0.96.

If temperature is accurately detected, appropriate actions or precautions can be taken, for example, dispensing material onto a roadway to melt ice or snow, or prevent loss of traction. However, if temperature is not accurately determined, unnecessary actions or precautions may be taken, which could, for example, lead to unnecessary use of materials and associated expenses. Additionally, inaccurate measurement can cause necessary actions or precautions not to be taken, which can result, in a roadway example, in unsafe driving conditions, congested traffic, etc.

There are several IR temperature sensor calibrators on the market. These are often termed black body targets. These devices usually have relatively small target areas and use a correction factor to compensate for different emissivities. They also employ a complex and expensive electric cooling and heating device to control temperature. The target surface is then measured at a single point. These active devices are very inefficient and are susceptible to creating non-uniform temperatures throughout the target surface and require regular and costly recalibrations.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

In aspects, the subject innovation can comprise a system that facilitates calibrated temperature measurements. Such a system can include a target object that changes temperature, and the system can facilitate calibration of a test infrared (IR) temperature sensor that can make a first set of measurements of the temperature of the target object over a period of time. The system can also include a standard IR temperature sensor that can make a second set of measurements of the temperature of the target object over the period of time. Additionally, the system can include a calibration unit that compares the first set of measurements with the second set of measurements and determines an accuracy of the test IR temperature sensor based on the comparison.

In other aspects, the subject innovation can comprise a method of facilitating calibrated temperature measurements. The method can include the acts of setting a target object to a starting temperature distinct from an ambient temperature, measuring via a test sensor the temperature of the target object as the temperature changes over a period of time, and measuring via a standard sensor the temperature of the target object as the temperature changes over a period of time. Additionally, the method can include the steps of comparing the temperature measured via the test sensor with the temperature measured via the standard sensor and determining, based at least in part on the comparing, an accuracy of the test sensor.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system capable of calibrating or verifying the accuracy of one or more infrared temperature sensors to be tested in accordance with aspects of the subject innovation.

FIG. 2 illustrates a methodology of calibrating and/or verifying a test sensor in accordance with aspects of the innovation.

FIG. 3 illustrates an example schematic showing an arrangement of a test sensor, a standard sensor, a calibration unit, and a target object in one example embodiment of the subject innovation.

FIG. 4 illustrates a perspective drawing of an example embodiment of a calibration unit in accordance with aspects of the subject innovation.

FIG. 5 shows a perspective image of another example embodiment of the subject innovation.

FIG. 6 illustrates a block diagram of a computer operable to execute the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

In aspects, systems and methods of the subject innovation can facilitate calibration of one or more infrared temperature sensors. Systems and methods of the subject innovation can provide for field calibration of one or more test sensors via the use of a passive target object or device. In various aspects, the subject innovation can provide a novel, reliable, and cost-efficient manner of field calibration (or verification) of infrared temperature sensors.

In aspects, systems and methods of the subject innovation can use a passive block or other object as a calibration target object. The block can be made of specially chosen material that conducts and retains heat to assure a uniform and stable temperature. Additionally, a special surface coating can be used on the target object, to provide a high fidelity model which closely reproduces the way the sensors operate in the real world application. At the factory, the object's temperature can be precisely measured using a certified and traceable temperature sensor. This reading can then be used to certify an IR sensor which can be included with a system of the subject innovation. This standard can be a traceable measurement useable to indicate the target object's temperature during normal operation.

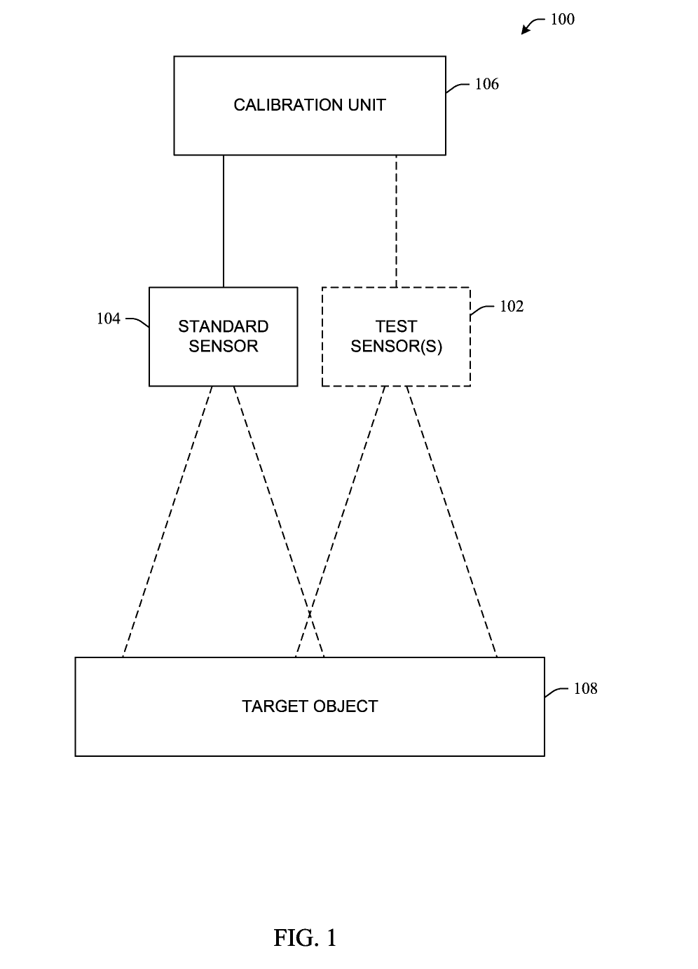

Turning to FIG. 1, shown is a system 100 capable of calibrating or verifying the accuracy of one or more test infrared temperature sensors to be tested (“test IR temperature sensors,” “test sensors” or “units under test”) 102, in accordance with aspects of the subject innovation. System 100 can comprise a standard or reference sensor 104, a calibration unit 106, and a target object 108, which together can one or more of provide information to verify the accuracy of the one or more test sensors 102 or information useable to manually calibrate (e.g., including compensating for discrepancies of) the one or more test sensors 102, or can automatically calibrate the one or more test sensors 102.

Standard or reference infrared temperature sensor (“standard IR temperature sensor” or “standard sensor”) 104 can be any of a variety of infrared temperature sensors, such as active or passive infrared sensors useable for measuring a road surface temperature, including those described in U.S. Pat. Nos. 5,796,344, 6,166,657 or 6,206,299 (the entireties of each of which are incorporated herein by reference), or the RoadWatch® brand sensor system, etc. In alternative embodiments, other infrared temperature sensors can be used as standard sensor 104. Standard sensor 104 can be an infrared temperature sensor verified and/or calibrated under controlled conditions. For example, standard sensor 104 can be verified and/or calibrated based on measurements of target object 108 or a similar item in connection with any of a plurality of means of accurately measuring the temperature of target object 108 or the similar item, such as in controlled conditions at a factory or other locations, for example, by using a certified and traceable temperature sensor. By verifying and/or calibrating standard sensor 104, standard sensor 104 can be used as an accurate reference for verification and/or calibration of the one or more test sensors 102.

In various aspects, standard sensor 104 can be mounted in (e.g., removably, etc.) a sensor port of calibration unit 106 and one or more test sensors 102 can be mounted in one or more other sensor ports of calibration unit 106, by which the arrangement of standard sensor 104 and the one more test sensors 102 can be positioned to receive comparable signals from a single target object 108, which can improve the accuracy of verification and/or calibration.

Calibration unit 106 can provide an interface for interaction with the one or more test sensors 102, standard sensor 104, and can facilitate verification and/or calibration of the one or more test sensors 102 based on measurements of the standard sensor 104. Additionally, unit 106 can provide a housing for one or more of test sensor(s) 102, standard sensor 104, and target object 108, maintaining the sensors and target object in position relative to one another to ensure accurate measurement of target object 108 by test sensor(s) 102 and standard sensor 104. Calibration unit can comprise an internal or external power supply (e.g., a 5V DC power supply, etc.) to provide power to calibration unit 106 and potentially other components of system 100. Calibration unit 106 can display temperature readings (e.g., in Fahrenheit, Celsius, etc.) for sensors 102 or 104 mounted in it or otherwise coupled to it. Additionally, calibration unit 106 can provide further information to a user of system 100, such as progress on calibration (e.g., via an indicator showing that calibration testing is in progress or has been completed, displaying an amount by which a test sensor 102 needs to be calibrated or has been calibrated, etc.), a serial number or other identifying information for a test sensor 102 connected to calibration unit 106, etc.

Target object 108 can be made of any of a variety of materials, and can have a relatively high heat capacity and thermal conductivity such that it can transition slowly between temperatures while maintaining a substantially constant temperature throughout the target object 108 (e.g., minimal temperature gradient, etc.). In one embodiment, target object 108 can be made of aluminum, although other metals (e.g., copper, silver, etc.) can be used, as can non-metallic materials (e.g., ceramics, etc.), or other materials with material properties such as those described herein. Target object 108 can be treated with a surface treatment to set its emissivity to a specified emissivity (e.g., anything from 1 (black body) down to 0, such as 0.96 (an emissivity corresponding to that of concrete or asphalt, etc.), 0.90, etc.).

The target object 108 of system 100 can be set to a starting temperature different than an ambient temperature (e.g., room temperature, etc.). As the temperature of target object 108 changes, the test sensor(s) 102 and standard sensor 104 can measure the temperature of the target object 108 over time, each taking a set of measurements of the temperature of the target object 108. Calibration unit 106 can compare the measurements from test sensor(s) 102 and standard sensor 104. Based on the comparison, calibration unit 106 can determine the accuracy of the test sensor(s) 102. For example, if the measurements agree to within a threshold (e.g., a predetermined value, e.g., a small number of degrees Fahrenheit or Celsius, such as a fraction of a degree, one degree, or more or less, etc.) over the course of a measurement period (e.g., a predetermined amount of time, the time required for target object 108 to reach ambient temperature or a different temperature, etc.), calibration unit 106 can verify that the test sensor(s) 102 are accurate (it is to be appreciated that when more than one test sensor is used, separate results can be obtained for each). However, if the measurements of the test sensor(s) 102 and the standard sensor 104 do not agree within the predetermined threshold, calibration unit 106 can determine that the test sensor(s) 102 require calibration. In aspects, calibration unit 106 can automatically calibrate test sensors 102 determined to require calibration, such that measurements of such test sensors 102 after calibration correspond to those of the standard sensor 104. Optionally, after calibration, test sensor(s) 102 can be re-checked or re-verified to determine that measurements correspond to those of standard sensor 104 to within the threshold. Optionally, if measurements of the test sensor(s) 102 do not match those of standard sensor 104 to within the predetermined threshold after some fixed number of calibration attempts (e.g., one, two, etc.), the test sensor(s) 102 can be determined to be defective and in need of replacement.

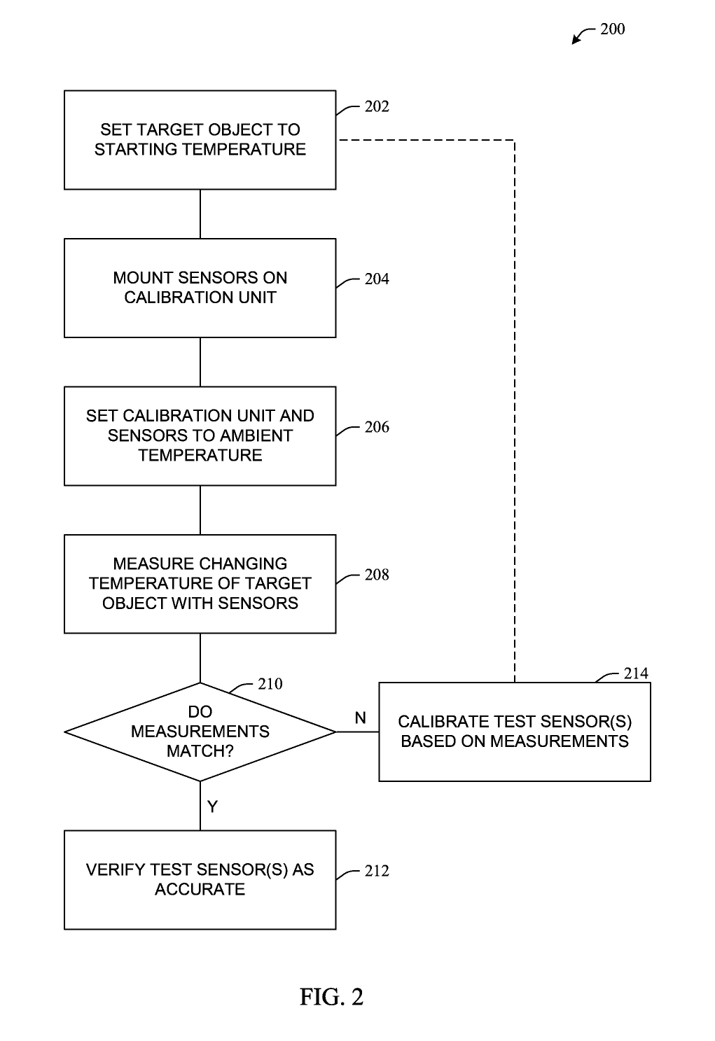

Referring now to FIG. 2, there is illustrated a methodology 200 of calibrating and/or verifying a test sensor in accordance with aspects of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Method 200 can begin at 202, wherein a target object (e.g., target object 108) can be set to a starting temperature, e.g., by placing it in an appropriate location or environment for a sufficient period of time (e.g., 30 minutes, etc.) to achieve the starting temperature (e.g., around 32° F. (0° C.) in a roadway icing sensor application, etc.) uniformly throughout the target object. The starting temperature may vary depending on the particular applications for which the sensors are to be used, and the time required can depend on the initial temperature of the target object, first temperature, material properties of target object, etc.

At 204, sensors (e.g., standard sensor, test sensor(s), etc.) can be mounted on a calibration unit if not mounted on the calibration unit already. In aspects, the standard sensor can be mounted in a different location than test sensor(s); in one embodiment, a sensor port. Next, at 206, the calibration unit, standard sensor, and one or more test sensors can be set to an ambient temperature (e.g., room temperature, etc.) different from the starting temperature. Again, depending on the temperature these components were previously at, material properties, and other factors, this may take some period of time (e.g., 20 minutes, etc.).

At 208, the target object can be placed within a field of view of the test sensor(s) and standard sensor if necessary, and the sensors can measure the temperature of the target object as its temperature changes from the starting temperature to the ambient temperature. At 210, the temperature measurements over time from the test sensor(s) can be compared to those of the standard or reference sensor to determine an accuracy of the test sensor, for example, by determining whether the measurements from the test sensor(s) are within a predetermined threshold of the measurements from those of the standard sensor. If the measurements do correspond to within a predetermined threshold, then at 212, the test sensor(s) can be verified as accurate. However, if the measurements of the test sensor(s) do not match those of the standard sensor to within a predetermined threshold, then at 214, the test sensor(s) can be calibrated based at least in part on the measurements (e.g., by adjusting the calibration of the test sensor(s) based on the difference in measurements to correspond to those of the standard sensor, etc.). Optionally, from 214, the method can then return to 202 to repeat, so as to verify the accuracy of the calibrated test sensor(s). Additionally, although not illustrated in FIG. 2, if the measurements of the calibrated test sensor(s) do not match within a predetermined threshold of those of the standard sensor after some number of calibration attempts, a determination can be made that the test sensor(s) do not match

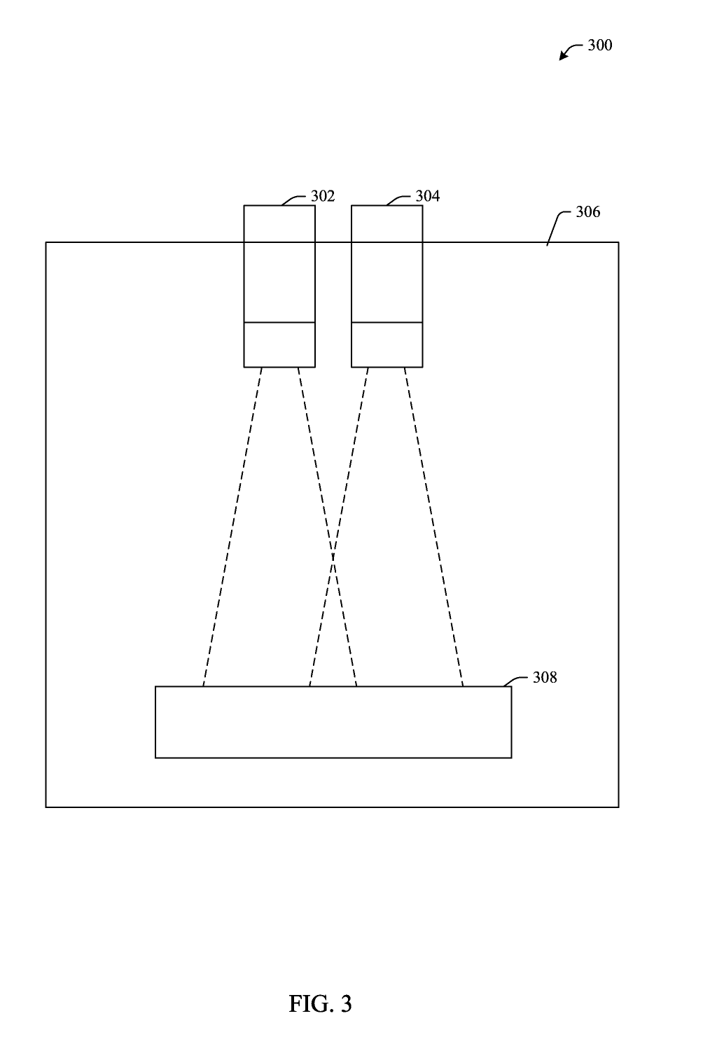

Turning to FIG. 3, illustrated is an example schematic showing an arrangement of test sensor 302, standard sensor 304, calibration unit 306, and target object 308 in one example embodiment. It is to be understood, however, that in other embodiments, these components may be arranged differently.

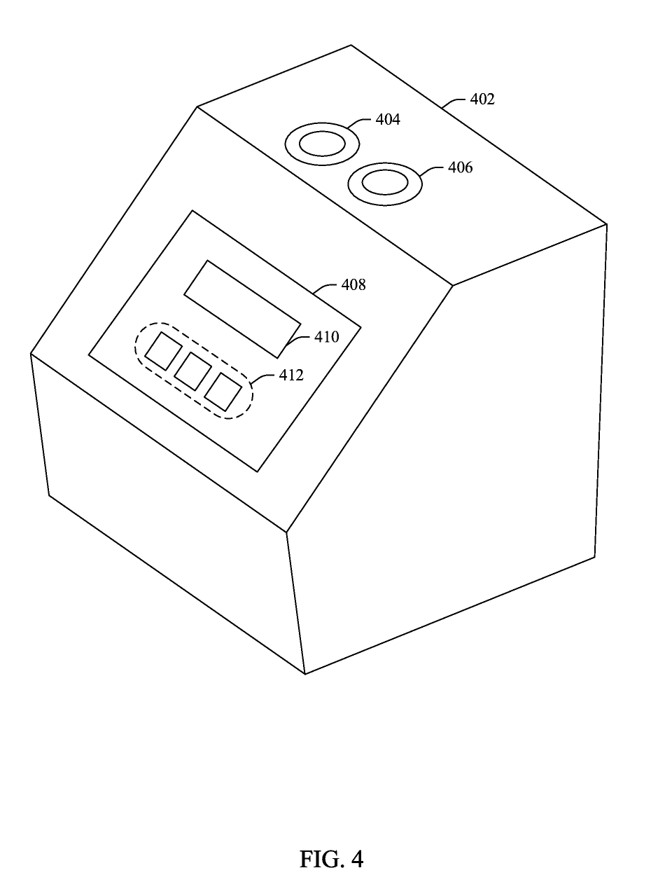

FIG. 4 illustrates a perspective drawing of an example embodiment of the subject innovation. In aspects, the subject innovation can comprise a calibration unit 402. Calibration unit 402 can include one or more test sensor ports 404 wherein one or more test sensors can be mounted, and can also include at least one standard sensor port 406 for mounting a standard sensor. Additionally, calibration unit 402 can include a user interface 408, which can include one or more output devices 410 such as a screen, speakers, etc., and one or more input devices 412 such as buttons, etc. Calibration unit 402 can include a staging area that can provide for consistent placement of a target object (e.g., target object 108, etc.) used to calibrate sensors. For example, the sensor ports 404 and 406 can be arranged relative to the staging area such that when a target object is placed in the staging area, sensors placed in both a test sensor port 404 and a standard sensor port 406 have similar images of the target object, which can facilitate accurate and consistent calibration of test units.

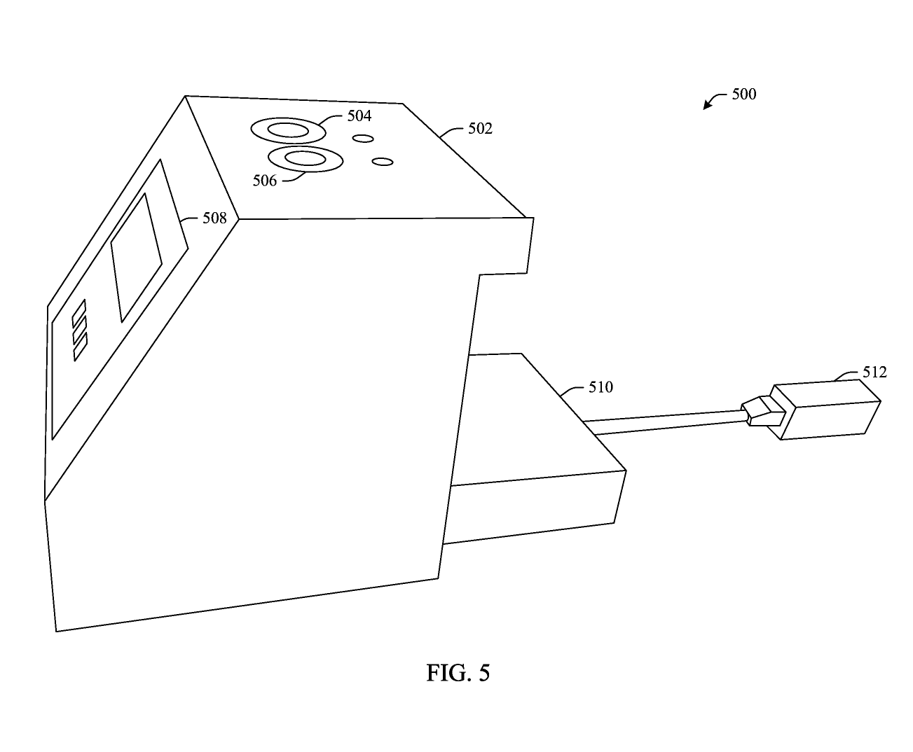

FIG. 5 shows a perspective image of a calibration unit 502 of the subject innovation, comprising one or more test sensor ports 504, at least one standard sensor port 506, and a user interface 508. A standard sensor (e.g., standard sensor 104) can be verified or calibrated (e.g., in controlled conditions, etc.) by calibrating measurements of target object 510 by the standard sensor based on substantially contemporaneous measurements of target object 510 by a primary standard 512. Primary standard 512 can be an IR sensor that is more accurate than sensors used for field measurements. By calibrating the standard sensor to primary standard 512, the accuracy of the standard sensor used for field calibration can be greater than it otherwise would be.

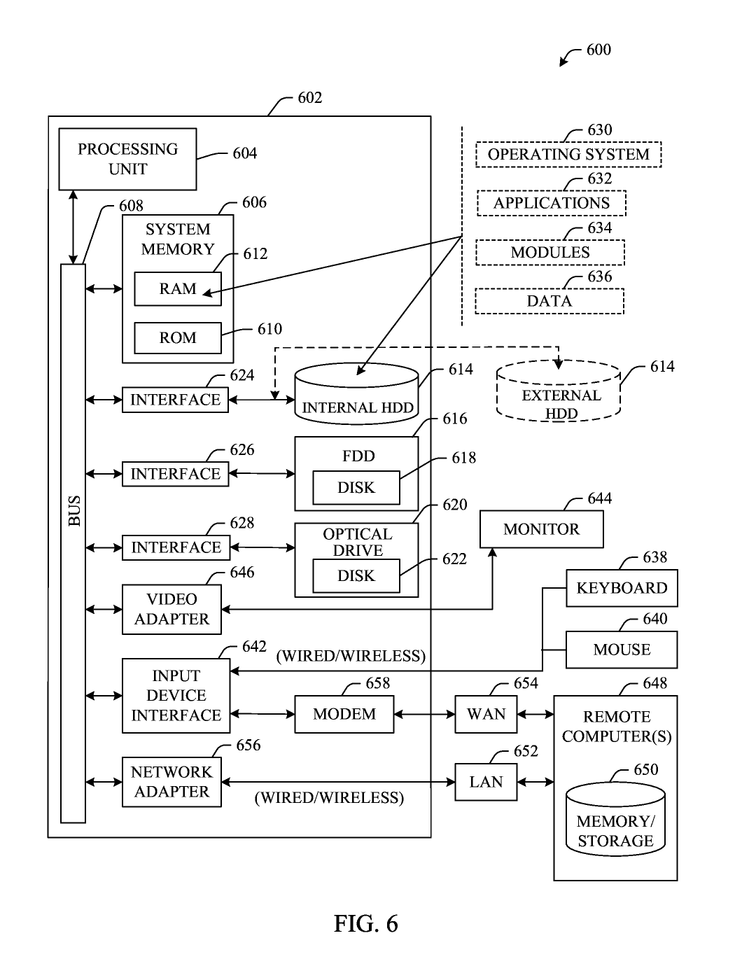

Referring now to FIG. 6, there is illustrated a block diagram of a computer capable of executing some of the features and/or components of the subject innovation. In order to provide additional context for various aspects of the subject innovation, FIG. 6 and the following discussion are intended to provide a brief, general description of a suitable computing environment 600 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 6, the exemplary environment 600 for implementing various aspects of the innovation includes a computer 602, the computer 602 including a processing unit 604, a system memory 606 and a system bus 608. The system bus 608 couples system components including, but not limited to, the system memory 606 to the processing unit 604. The processing unit 604 can be any of various commercially available processors. Dual microprocessors and other multi-processor architectures may also be employed as the processing unit 604.

The system bus 608 can be any of several types of bus structure that may further interconnect to a memory bus (with or without a memory controller), a peripheral bus, and a local bus using any of a variety of commercially available bus architectures. The system memory 606 includes read-only memory (ROM) 610 and random access memory (RAM) 612. A basic input/output system (BIOS) is stored in a non-volatile memory 610 such as ROM, EPROM, EEPROM, which BIOS contains the basic routines that help to transfer information between elements within the computer 602, such as during start-up. The RAM 612 can also include a high-speed RAM such as static RAM for caching data.

The computer 602 further includes an internal hard disk drive (HDD) 614 (e.g., EIDE, SATA), which internal hard disk drive 614 may also be configured for external use in a suitable chassis (not shown), a magnetic floppy disk drive (FDD) 616, (e.g., to read from or write to a removable diskette 618) and an optical disk drive 620, (e.g., reading a CD-ROM disk 622 or, to read from or write to other high capacity optical media such as the DVD). The hard disk drive 614, magnetic disk drive 616 and optical disk drive 620 can be connected to the system bus 608 by a hard disk drive interface 624, a magnetic disk drive interface 626 and an optical drive interface 628, respectively. The interface 624 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 602, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 612, including an operating system 630, one or more application programs 632, other program modules 634 and program data 636. All or portions of the operating system, applications, modules, and/or data can also be cached in the RAM 612. It is appreciated that the innovation can be implemented with various commercially available operating systems or combinations of operating systems.

A user can enter commands and information into the computer 602 through one or more wired/wireless input devices, e.g., a keyboard 638 and a pointing device, such as a mouse 640. Other input devices (not shown) may include a microphone, an IR remote control, a joystick, a game pad, a stylus pen, touch screen, or the like. These and other input devices are often connected to the processing unit 604 through an input device interface 642 that is coupled to the system bus 608, but can be connected by other interfaces, such as a parallel port, an IEEE 1394 serial port, a game port, a USB port, an IR interface, etc.

A monitor 644 or other type of display device is also connected to the system bus 608 via an interface, such as a video adapter 646. In addition to the monitor 644, a computer typically includes other peripheral output devices (not shown), such as speakers, printers, etc.

The computer 602 may operate in a networked environment using logical connections via wired and/or wireless communications to one or more remote computers, such as a remote computer(s) 648. The remote computer(s) 648 can be a workstation, a server computer, a router, a personal computer, portable computer, microprocessor-based entertainment appliance, a peer device or other common network node, and typically includes many or all of the elements described relative to the computer 602, although, for purposes of brevity, only a memory/storage device 650 is illustrated. The logical connections depicted include wired/wireless connectivity to a local area network (LAN) 652 and/or larger networks, e.g., a wide area network (WAN) 654. Such LAN and WAN networking environments are commonplace in offices and companies, and facilitate enterprise-wide computer networks, such as intranets, all of which may connect to a global communications network, e.g., the Internet.

When used in a LAN networking environment, the computer 602 is connected to the local network 652 through a wired and/or wireless communication network interface or adapter 656. The adapter 656 may facilitate wired or wireless communication to the LAN 652, which may also include a wireless access point disposed thereon for communicating with the wireless adapter 656.

When used in a WAN networking environment, the computer 602 can include a modem 658, or is connected to a communications server on the WAN 654, or has other means for establishing communications over the WAN 654, such as by way of the Internet. The modem 658, which can be internal or external and a wired or wireless device, is connected to the system bus 608 via the serial port interface 642. In a networked environment, program modules depicted relative to the computer 602, or portions thereof, can be stored in the remote memory/storage device 650. It will be appreciated that the network connections shown are exemplary and other means of establishing a communications link between the computers can be used.

The computer 602 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates calibrated temperature measurements, comprising:
a target object that changes temperature;
a test infrared (IR) temperature sensor that makes a first set of measurements of the temperature of the target object over a period of time;
a standard IR temperature sensor that makes a second set of measurements of the temperature of the target object over the period of time; and
a calibration unit that compares the first set of measurements with the second set of measurements and determines an accuracy of the test IR temperature sensor based on the comparison.

2. The system of claim 1, wherein the calibration unit one of verifies the accuracy of the test IR temperature sensor based on the comparison or determines an extent of calibration needed for the test IR temperature sensor.

3. The system of claim 2, wherein the calibration unit automatically calibrates the test IR temperature sensor based on the determined extent of calibration needed.

4. The system of claim 3, wherein the calibration unit re-verifies the accuracy of the test IR temperature sensor based at least in part on comparison between a third set of measurements of the temperature of the target object taken by the test IR temperature sensor with a fourth set of measurements of the temperature of the target object taken by the standard IR temperature sensor, wherein the third set of measurements and the fourth set of measurements are taken after calibration of the test IR temperature sensor.

5. The system of claim 1, wherein the standard IR temperature sensor is a road surface temperature sensor.

6. The system of claim 1, wherein the test IR temperature sensor is a road surface temperature sensor.

7. The system of claim 1, wherein the target object comprises an aluminum block.

8. The system of claim 1, wherein the target object comprises a surface treatment that provides the target object with a pre-determined emissivity.

9. The system of claim 8, wherein the emissivity is 0.96.

10. The system of claim 1, wherein the standard IR temperature sensor has been calibrated under controlled conditions.

11. The system of claim 1, wherein the standard IR temperature sensor and the test IR temperature sensor are both mounted in the calibration unit.

12. A method of facilitating calibrated temperature measurements, comprising:
setting a target object to a starting temperature distinct from an ambient temperature;
measuring via a test sensor the temperature of the target object as the temperature changes over a period of time;
measuring via a standard sensor the temperature of the target object as the temperature changes over a period of time;
comparing the temperature measured via the test sensor with the temperature measured via the standard sensor; and
determining, based at least in part on the comparing, an accuracy of the test sensor.

13. The method of claim 12, further comprising calibrating the test sensor based at least in part on the determined accuracy.

14. The method of claim 13, wherein the steps of setting, measuring via the test sensor, measuring via the standard sensor, comparing, and determining are repeated after calibrating the test sensor.

15. The method of claim 12, wherein the target object has an emissivity of 0.96.

16. The method of claim 12, wherein the starting temperature is at or below 32° F.

17. The method of claim 12, further comprising mounting the test sensor and the standard sensor in a calibration unit.

18. The method of claim 12, further comprising setting the test sensor and the standard sensor to the ambient temperature.

19. The method of claim 12, wherein the period of time is the time required for the target object to reach the ambient temperature.

20. A calibration unit that facilitates calibration of a test infrared (IR) sensor, comprising:
a standard sensor port adapted to mount a standard IR sensor;
a test sensor port adapted to mount the test IR sensor; and
a staging area adapted to mount a target object.
